(19) United States
(12) Patent Application Publication
(10) Pub. No.: US 2015/0061495 A1
(43) Pub. Date: Mar. 5, 2015

(54) EMERGENCY-ACTIVATED NIGHT LIGHT AND METHODS FOR ACTIVATING SAME

(71) Applicant: Life+Gear, Inc., San Diego, CA (US)

(72) Inventor: Dennis Bertken, San Diego, CA (US)

(21) Appl. No.: 14/469,833

(22) Filed: Aug. 27, 2014

Related U.S. Application Data
(60) Provisional application No. 61/871,163, filed on Aug. 28, 2013.

(51) Int. Cl. H05B 33/08; H02J 9/06; H05B 37/02

(52) U.S. Cl. CPC H05B 33/0854; H05B 37/0236; H05B 37/0218; H02J 9/06
USPC 315/86; 315/297; 315/152

(57) ABSTRACT

An emergency lighting device, having a lighting device housing and power source, includes an illumination circuit powered by the power source. The illumination circuit is configured to trigger a first illumination mode having a first non-zero lumen output responsive to a first condition and a second illumination mode having a second, different, non-zero lumen output responsive to a second condition. In a preferred embodiment, the first non-zero lumen output is lower than the second non-zero lumen output. One or more light sources are retained within the lighting device housing and configured to provide illumination outside of said housing responsive to the first or second illumination mode. Finally, a signal detector retained within the lighting device housing is operative to trigger the second condition responsive to detection of a signal which, in a preferred embodiment is an audible signal such as a fire or smoke alarm signal.

### CROSS-REFERENCE TO RELATED APPLICATION

The present application claims the benefit of U.S. Provisional Patent Application No. 61/871,163, which is titled “EMERGENCY-ACTIVATED NIGHT LIGHT AND METHODS FOR ACTIVATING SAME” and was filed on Aug. 28, 2013, the content of which is hereby incorporated by reference herein in its entirety.

### BACKGROUND OF THE INVENTION

This invention relates generally to lighting devices and more particularly to nightlights incorporating multi-mode operation.

Conventional nightlights are configured to plug into a power outlet and be operated using a single on-off switch to activate a low-wattage bulb. A more recent variation on such a nightlight uses a light sensor to turn on the nightlight bulb only when the ambient light drops below a certain threshold, but deactivates the light otherwise. All such nightlights are often used in low-light areas for safety and security purposes. When used along a hallway, for instance, such nightlights provide just enough light during the nighttime to allow one to proceed slowly down such hallway by illuminating potential tripping hazards.

During emergencies, such as when rapid egress of a location is needed, more light than is typical for nightlights may be needed. However, conventional nightlights are not intended to provide full ambient illumination as such would be power-prohibitive and would defeat the limited purpose of such nightlights. Instead, a home-owner would typically switch on the regular lights to provide such additional illumination. But such actions may take additional time to accomplish, is made more difficult by people's panicked reaction to such emergencies, and may be worthless if power is cut-off to the house due to the emergency.

While conventional nightlights have typically served a single purpose—that is to provide low, localized light—there is a need for more sophisticated light sources that have an additional activation state during emergencies such as fires, earthquakes, burglaries, etc.

### SUMMARY OF THE INVENTION

One aspect of the invention comprises an emergency lighting device having a lighting device housing and power source. The lighting device includes an illumination circuit powered by the power source. The illumination circuit is configured to trigger a first illumination mode having a first non-zero lumen output responsive to a first condition and a second illumination mode having a second, different, non-zero lumen output responsive to a second condition. In a preferred embodiment, the first non-zero lumen output is lower than the second non-zero lumen output. One or more light sources are retained within the lighting device housing and configured to provide illumination outside of said housing responsive to the first or second illumination mode. Finally, a signal detector retained within the lighting device housing is operative to trigger the second condition responsive to detection of a signal which, in a preferred embodiment is an audible signal such as a fire or smoke alarm signal.

In another aspect of the invention, an emergency lighting device comprises a lighting device housing having a translucent peripheral portion. A first set of light sources are spaced along and directed outward from the translucent peripheral portion and configured to illuminate along at least a substantial length of the peripheral portion. A second set of light sources are pivotally coupled along a bottom of the lighting device housing and configured to illuminate downward from the housing. The lighting device further includes means for energizing the first and second set of light sources, with the means including a first mode in which at least one of the first and second set of light sources is energized to illuminate with a first non-zero lumen output and a second mode in which at least one of the first and second set of light sources is energized to illuminate with a second non-zero lumen output. So that an observer can distinguish between modes, and so that additional illumination is provided when an emergency signal is detected, the second non-zero lumen output is higher than said first non-zero lumen output. Finally, an audible signal detector is operatively coupled to at least one of the first and second set of light sources to trigger the at least one of the first and second set of light sources to the second mode responsive to a detected audible signal.

Also disclosed herein is a method for operating a nightlight of a type having one or more light sources and a signal detector. The method comprises operating the one or more light sources in a first mode having a first non-zero lumen output, detecting a signal using the signal detector, and, responsive to the step of detecting the signal, operating the one or more light sources in a second mode having a second non-zero lumen output, wherein the second non-zero lumen output is larger than the first non-zero lumen output.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a perspective view of a lighting device according to a preferred embodiment of the invention.

FIG. 2 is a plan view of the lighting device from FIG. 1 with lighting elements, configured according to one embodiment of the invention, shown in broken lines.

FIG. 3 is a section side view taken along line 3-3 of FIG. 2, showing a pivoting housing in a non-pivoted position as configured according to a preferred embodiment of the invention.

FIG. 4 is a section side view of the pivoting housing of FIG. 3 disposed in a pivoted position at an angle to a plane of the lighting device housing.

FIG. 5 is a section side view of the lighting device taken along line 5-5 of FIG. 2.

FIG. 6 is an exploded perspective view of the lighting device of FIG. 1.

FIG. 7 illustrates a first portion of an illumination circuit of the lighting device showing the AC to DC power supply and multiple light sources.

FIG. 8 illustrates a signal detector circuit configured according to an embodiment of the invention.

FIG. 9 illustrates an optical sensor circuit configured according to an embodiment of the invention.

FIG. 10 illustrates a circuit control element configured according to an embodiment of the invention to operate the light sources of FIG. 7 in one or multiple possible illumination modes.

### DETAILED DESCRIPTION

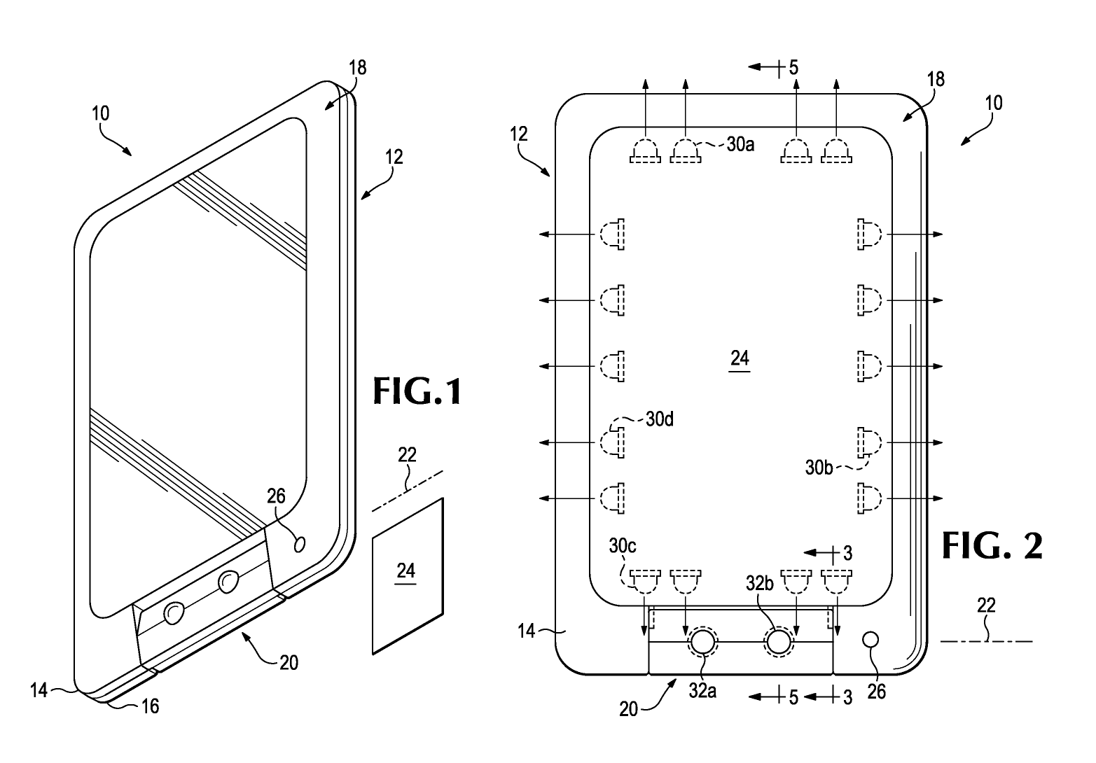

FIG. 1 illustrates a nightlight 10 as configured according to a preferred embodiment of the invention. Nightlight 10 includes a lighting device housing 12 having front and rear shells 14, 16 coupled together to form an interior cavity 42 in which the electronics and light sources are enclosed as described further below. At least a peripheral portion 18 of shells 14, 16 are preferably translucent (or possibly transparent) to allow light emanating from the interior cavity 42 of the housing 12 to pass through the portions adjacent the light sources and thence to the exterior of the housing. In one embodiment, the light sources are spaced about and illuminate a substantial length of the peripheral portion 18.

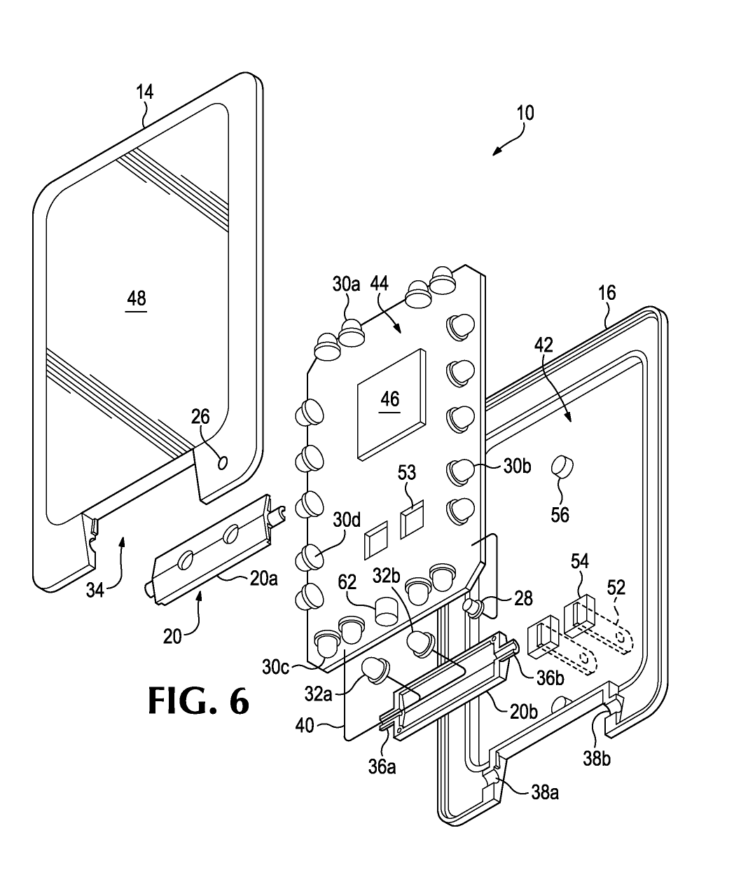

Front and rear shells 14, 16 are shaped in a substantially rectangular arrangement and sized to be approximately equal to that of a standard duplex wall plate. A pivot housing 20 is coupled within a notched cutout formed at a bottom of the lighting device housing 12 along a horizontal axis of the pivot housing 20 and in a plane 24 of the lighting device housing 12. An aperture 26 is formed through the front shell 14 of the light device housing 12 and exposes a photoelectric cell 28 (FIG. 6) whose purpose and operation is discussed further below with reference to FIG. 9.

FIG. 2 is a plan view of the nightlight lighting device 10. A plurality of light sources forming a first set—such as LEDs 30a-30d—are retained within a cavity 42 formed within the housing 12 and spaced about a periphery of the housing. In one embodiment of the invention, this first set of light sources project out all sides of the lighting device housing 12 so that, when the device 10 is plugged into a wall socket the LEDs 30a-30b project onto and illuminate the top, right, bottom, and left wall surfaces, respectively, adjacent the mounted lighting device 10. A second set of light sources 32a, 32b are retained within the pivot housing 20 and driven using the same illumination circuit through multiple lighting modes as discussed further below. Although a total of 20 LEDs are shown, the invention is not so limited to this number and any light sources in any configuration may be used so long as the lighting device 10 exhibits two non-zero illumination modes.

Examples of illuminations modes are as follows. In a first variation, an illumination circuit is configured to operate all of the one or more light sources (e.g. LEDs 30a-30d and adjacent elements, and LEDs 32a and 32b) at a first non-zero lumen output in a first illuminations mode and operate all of the one or more light sources at a second non-zero lumen output in a second illumination mode, wherein the second non-zero lumen output is substantially greater than the first non-zero lumen output. That is, the light sources are driven at a first voltage in a normal/nightlight mode and at a higher voltage, to achieve higher illumination, in an emergency mode. In a second variation, the illumination circuit is configured to operate a first subset of the one or more light sources (e.g. LEDs 30b and 30d but not 30a, 30c, 32a, 32b, or adjacent light sources) at a first non-zero lumen output in a first illumination mode and operate a second subset of the one or more light sources (e.g. all the LEDs in the lighting device 10) at the second non-zero lumen output in a second illumination mode. The second subset can include the first subset, include only a portion of the first subset, or be an independent group from the first subset. Because more light sources are being driven in the second illumination mode, the second non-zero lumen output is substantially greater than the first non-zero lumen output. An example of the illumination difference between the modes is that the second/emergency mode is ten times the illumination of the normal/nightlight mode.

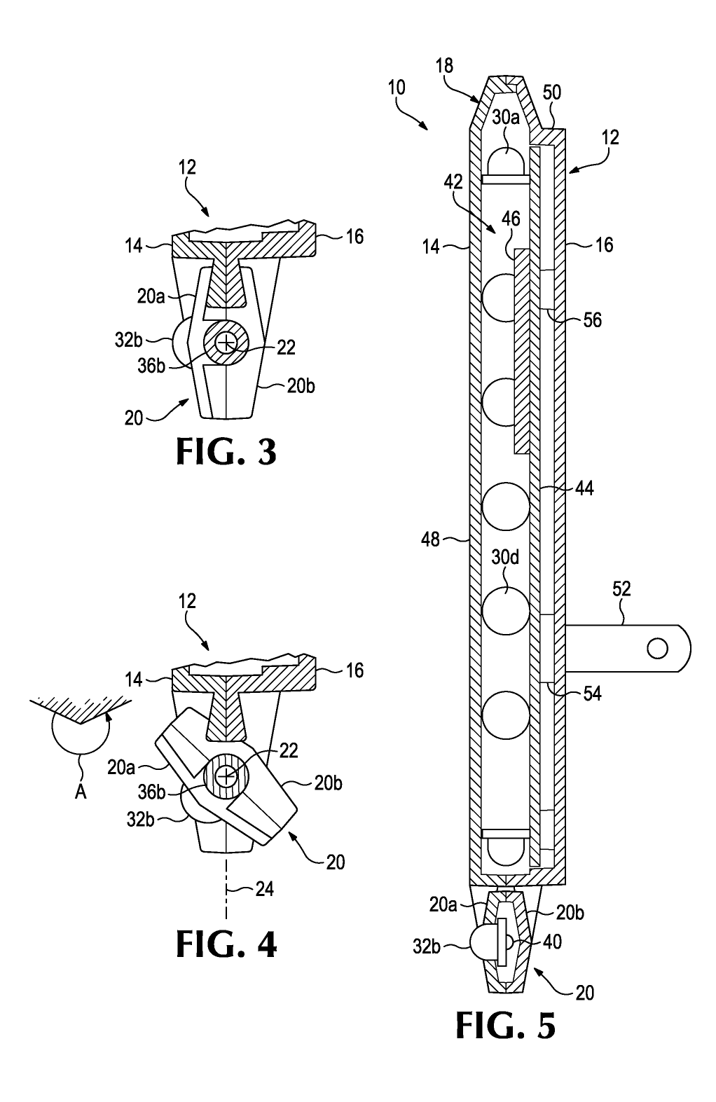

FIGS. 3 and 4 illustrate the direction-adjustable lighting of the lighting device 10. To effect directional lighting, lighting device housing 12 further includes a pivot housing 20 coupled to a bottom of the lighting device housing 12 along a horizontal axis 22 of the pivot housing and in a plane 24 of the lighting device housing 12. Pivot housing 20 is axially mounted within a notch 34 formed along a bottom edge of the front and rear shells 14, 16 via posts 36a, 36b extending axially on either side of housing 20. Posts 36a, 36b are received within complementary apertures 38a, 38b formed within either side of the notch 34 with electrical connections, e.g. wire 40, passing through at least one of the posts 36a. Such mounting enables illumination to be selectively directed from a second set of light sources—e.g. LEDs 32a, 32b—along an arc A downward in the plane 24 or outward at an angle from said plane of said lighting device housing 12.

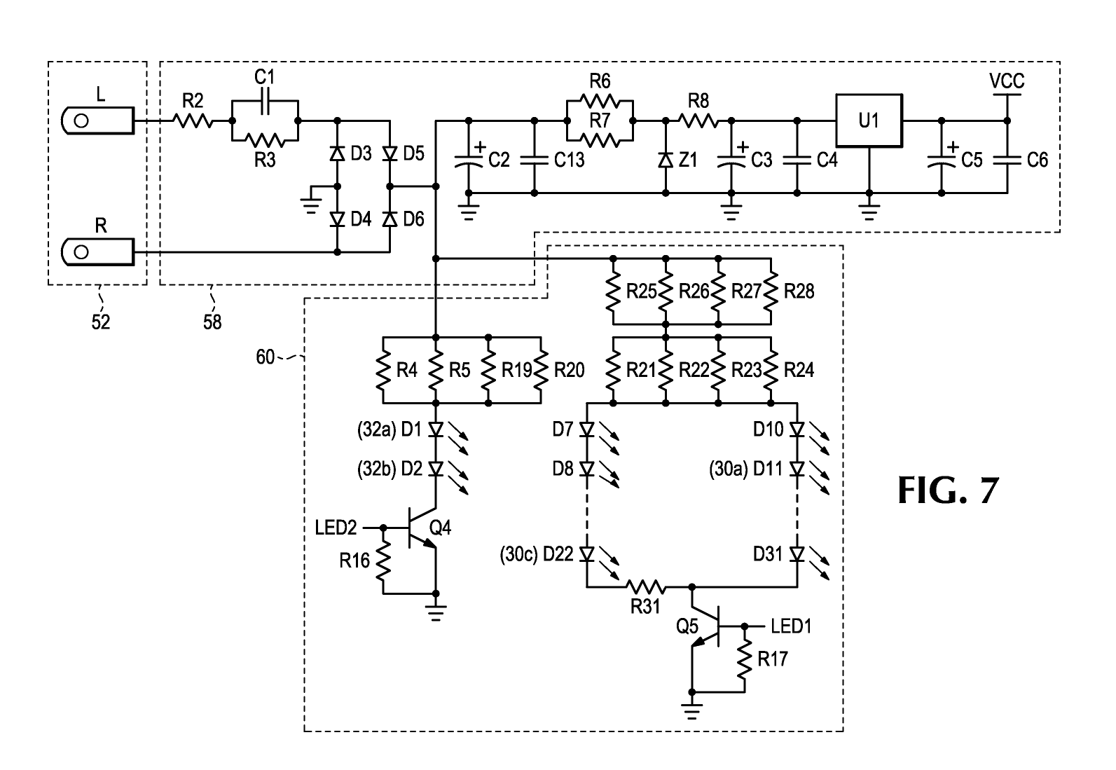

FIG. 5 shows a side view of the lighting device 10 taken along section line 5-5 in FIG. 2. This view shows the assembly of the lighting device using front and back shells 14, 16 to complete the lighting device housing 12 and the front and rear sections 20a, 20b to complete the pivot housing 20. Pivot housing 20 retains the second set of light sources, comprising LEDs 32a and 32b. Front and back shells 14, 16 are assembled together to enclose a cavity 42 into which is received a circuit board 44 and on which is mounted the plurality of light sources such as LEDs 30a-30d, a controller chip 46, and various circuitry as shown in FIGS. 7-10.

The front face 48 of front shell 14 is generally planar, and the rear face is planar as well to rest against a power outlet when installed and notched 50 to provide additional space for cavity 42. An AC power plug 52 extends out the rear face 50 of the lighting device housing and is coupled to circuit board 44, as via through holes 53, for providing operating power for lighting device 10, where plug 52 is configured by electrically inserted into a wall power outlet (not shown). The circuit board 44 is mounted within cavity 42 and spaced from the planar interior surface of rear shell 16 via lower spacers 54 on the proximal end of plug 52 and upper spacer 56. The assembled lighting device 10 comprises a thin profile with lights illuminating from an approximate radial center within a plane of the device with the exception of the pivot-mounted lights 32a, 32b that are positioned to direct light toward the floor when the lighting device is plugged into a wall outlet.

FIG. 6 shows an exploded perspective view of the lighting device 10 in which front shell 14. All elements retain numbering as described above.

FIG. 7 illustrates a first portion of an illumination circuit of the lighting device showing the AC to DC power supply and lighting elements comprising multiple light sources. AC power is supplied through plug 52 left and right prongs L, R to diode group D3, D4, D5 and D6. The AC to DC circuit 58 includes a converter chip U1 and a capacitor group comprising capacitors C2, C3, C5, C6, and C13. Power is thence transmitted to lighting source circuit 60 through resistor group 1 comprising resistors R21 through R28 and coupled to a first set of light sources D7 through D31 (which include LEDs 30a-30d), and a resistor group 2 comprising resistors R4, R5, R19, and R20 coupled to a second set of light sources D1, D2 (relating to LEDs 32a, 32b). The first set of light sources are located in spaced positions about the peripheral edge of the circuit board 44 and adjacent and directed out peripheral portions of the lighting device housing 12. The second set of light sources are mounted within the pivot housing 20 with activation of the light sources through transistor switches Q4 and Q5 respectively through programmable PIC microcontroller chip 46 shown in FIG. 10.

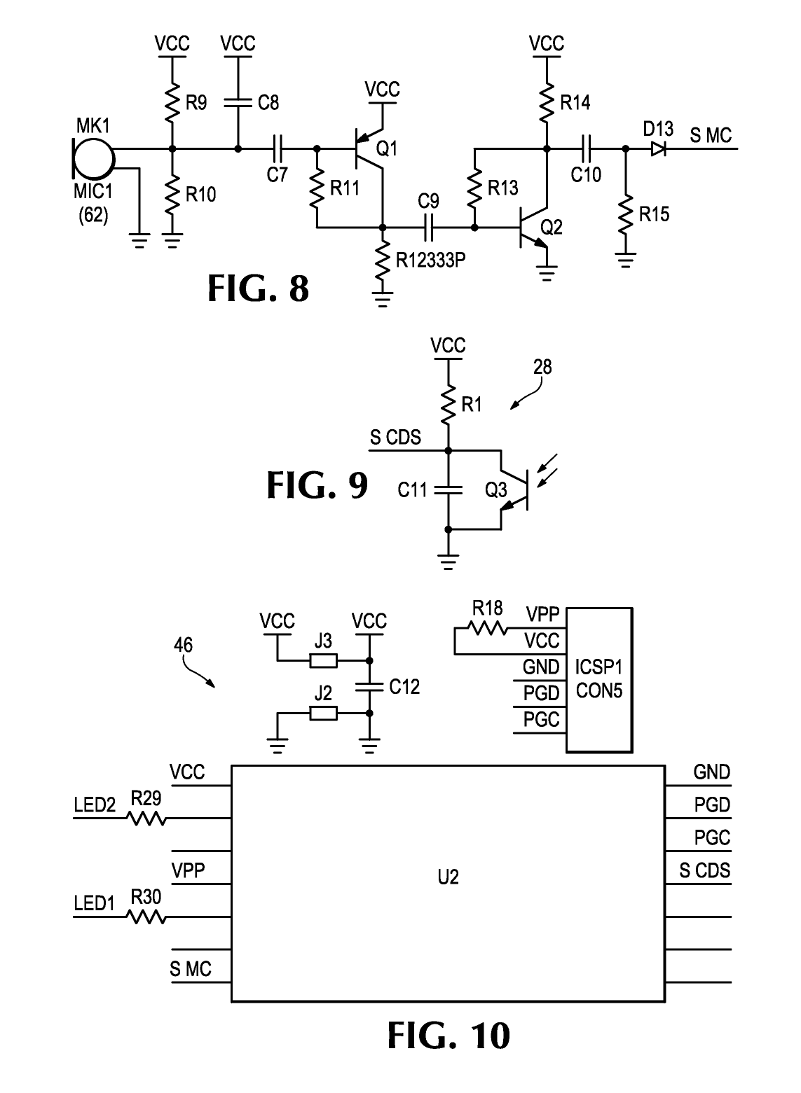

FIG. 8 illustrates a signal detector circuit configured according to an embodiment of the invention. In the preferred embodiment, the signal detector comprises an audible signal detector that includes a microphone 62 that outputs a frequency sensitive signal using the circuit shown in FIG. 8 to microcontroller chip 46 via input S MC. Microphone 62 is preferably a frequency selective microphone and, in the preferred embodiment, has a peak response from 2.6 to 3.4 kilohertz which includes the alarm signal frequencies of most commercially available smoke alarm devices. Alternately, a wide range microphone could be employed with a suitable bandpass filter (as illustrated in the circuit of FIG. 8). The circuit can be programmed to trigger the second/emergency illumination mode based upon a particular received frequency detected by microphone 62, by a particular volume detected, or both. In a preferred operation, the emergency nightlight 10 combines decibel level (e.g. 85 dBA) and frequency to activates the emergency mode of the nightlight. That is, the nightlight has standard lumen output when being used normally, but when an audible signal is detected that falls within the proscribed frequency range and exceeds a minimal decibel threshold, the light source output of the nightlight is boosted to a much higher lumen count. By using both, the nightlight 10 may be programmed to ignore false positives where a fire alarm issues from an adjacent property rather than a local one.

FIG. 9 illustrates an optical sensor circuit 28 configured according to an embodiment of the invention. Output signal S CDS is transmitted to an illumination circuit characterized by the programmable PIC microcontroller chip 46 for operation as disclosed further below. Circuit 28 includes a photoelectric cell Q3 operatively connected to the illumination circuit 46

FIG. 10 illustrates an illumination circuit control element configured according to an embodiment of the invention to operate the light sources of FIG. 7 in one or multiple possible illumination modes. Illumination circuit is characterized by a programmable PIC microcontroller chip 46, powered by the power source, and configured to trigger a first illumination mode having a first non-zero lumen output responsive to a first condition and a second illumination mode having a second non-zero lumen output responsive to a second condition, wherein the first non-zero lumen output is different (preferably greater) than the second non-zero lumen output. In operation, the illumination circuit 46 includes programming to determine whether the light sources—e.g. LEDs D1, D2, and D7 through D31—are illuminated at 30% power or 100% power. Other illuminations are of course possible without departing from the spirit of the invention comprising the means for energizing any or all of the first and second set of light sources.

The illumination circuit is further configured with a third mode in which the first and second set of light sources are not energized responsive to the state of signal received through input S CDS from the photocell circuit of FIG. 9. That is, the illumination circuit is configured to operate in the third mode where all LEDs are de-energized in response to sufficient illumination of said photoelectric cell. Otherwise, the illumination circuit is configured to operate in the first mode in the absence of a trigger by the signal detector of FIG. 8.

A normal nightlight operation, where the photocell does not detect a threshold minimum of ambient light, is treated as a first condition and results in the light sources illuminating with a low general light. As noted above, this operation may include energizing the light sources to low power or lighting only a small subset of the available light sources.

An emergency nightlight operation, where the microphone 62 picks up an audible smoke alarm signal, is treated as a second condition and results in the light sources illuminating with a maximal brightness. As noted above, this operation may include raising the power level to all LEDs from a lower to higher power. Alternately, this operation may include energizing additional LEDs to increase the total lumen output of the nightlight. These different sets of light sources can be the peripheral-fixed sources 30a-30d in a first group, and the pivotable sources 32a, 32b in a second group, or some mixture of the light sources.

Finally, the illumination circuit is further configured to trigger the second/emergency illumination mode responsive to a detected power failure through the AC power plug. In this case, a battery is enclosed in the housing 12 and electrically coupled to the illumination circuit or means for energizing the first and second set of light sources. The battery in this case is configured to provide operating power for said lighting device in the absence of power through the AC plug.

The application of the teachings of the present invention, although the design shown is specific to operation from an audible emergency signal, is not intended to be limited only to such an application. The teachings can be applied to any number of different emergencies or detected signal types merely by substituting the circuit of FIG. 8 with that specifically designed for the particular signal to be detected. For instance, a motion detector circuit may be used in place of the audible signal detector of FIG. 8 to trigger the second/emergency illumination mode responsive to a detected earthquake. Similarly, an NOAA alert detection circuit can be substituted in place of the FIG. 8 circuit to trigger the second/emergency illumination mode responsive to a received NOAA alert signal. For instance, the invention may be extended to a nightlight that substantially increases the lumen output responsive to a detected physical (e.g. earthquake shaking) displacement of the device at a particular frequency and/or Richter level. Finally, multiple detector circuits may be included to trigger the second/emergency illumination mode responsive to multiple different triggering events. Each of these may result in the triggering of various illumination types that vary by intensity, color, strobe, or various other lighting effects, etc.

Lastly, the sensor circuit (FIG. 8) and illumination circuit (FIG. 10) may be incorporated into various other packages to operate connected devices or devices into which such circuits are incorporated. One example of such a use for the invention includes incorporation of the circuit with battery backup into a light bulb. Another variation includes an outlet interface or remote that triggers a connected electronic device—such as a lamp, stereo, etc.—upon detection of the emergency signal. Such circuits may also be incorporated into lamps and wall sconces, and into alarm systems. Finally, such circuits may be incorporated into flashlights and/or lanterns for automated operation.

Having described and illustrated the principles of the invention in a preferred embodiment thereof, it should be apparent that the invention can be modified in arrangement and detail without departing from such principles. What is claimed is all modifications and variation coming within the spirit and scope of the following claims.

What is claimed is:

1. An emergency lighting device comprising:
a lighting device housing;
a power source;
an illumination circuit powered by the power source, and configured to trigger a first illumination mode having a first non-zero lumen output responsive to a first condition and a second illumination mode having a second non-zero lumen output responsive to a second condition, wherein the first non-zero lumen output is different from the second non-zero lumen output;
one or more light sources retained within the lighting device housing and configured to provide illumination outside of said housing responsive to the first or second illumination mode; and
a signal detector retained within the lighting device housing operative to trigger the second condition responsive to detection of a signal.

2. The emergency lighting device of claim 1, further including a battery enclosed in said housing, connected to said signal detector and said one or more light sources, and providing operating power for said device.

3. The emergency lighting device of claim 1, wherein said signal detector includes a frequency-selective microphone circuit and the signal is a smoke alarm audible signal.

4. The emergency lighting device of claim 1, wherein the signal is a detected physical displacement of the emergency lighting device.

5. The emergency lighting device of claim 1, further including an AC power plug extending out a rear face of the lighting device housing for providing operating power for said device.

6. The emergency lighting device of claim 4, the illumination circuit further being configured to trigger the second illumination mode responsive to a detected power failure through the AC power plug.

7. The emergency lighting device of claim 1, further including a second set of light sources pivotally coupled along a bottom of the lighting device housing and configured to illuminate downward from the housing.

8. The emergency lighting device of claim 1, wherein the illumination circuit is configured to operate all of the one or more light sources at the first non-zero lumen output in the first illuminations mode and operate all of the one or more light sources at the second non-zero lumen output in the second illumination mode, wherein the second non-zero lumen output is substantially greater than the first non-zero lumen output.

9. The emergency lighting device of claim 1, wherein the illumination circuit is configured to operate a first subset of the one or more light sources at the first non-zero lumen output in the first illumination mode and operate a second subset of the one or more light sources at the second non-zero lumen output in the second illumination mode, wherein the second non-zero lumen output is substantially greater than the first non-zero lumen output.

10. The emergency lighting device of claims 1, wherein the illumination circuit is further configured with a third mode in which the first and second set of light sources are not energized, said lighting device further including:
a photoelectric cell operatively connected to said illumination circuit, wherein said illumination circuit is configured to operate in the third mode in response to sufficient illumination of said photoelectric cell, otherwise configured to operate in the first mode in the absence of a trigger by the signal detector.

11. A method for operating a nightlight of a type having one or more light sources and a signal detector, the method comprising:
operating the one or more light sources in a first mode having a first non-zero lumen output;
detecting a signal using the signal detector; and
responsive to the step of detecting the signal, operating the one or more light sources in a second mode having a second non-zero lumen output, wherein the second non-zero lumen output is larger than the first non-zero lumen output.

12. The method of claim 11, wherein the signal is an audible fire or smoke alarm signal and the signal detector includes a frequency-sensitive microphone circuit.

13. The method of claim 11, wherein the first mode includes operating all of the one or more light sources at the first non-zero lumen output and the second mode includes operating all of the one or more light sources at the second non-zero lumen output.

14. The method of claim 11, wherein the first mode includes operating a first subset of the one or more light sources at the first non-zero lumen output and the second mode includes operating a second subset of the one or more light sources at the second non-zero lumen output.

15. The method of claim 13, wherein the second subset includes the first subset.

16. The method of claim 11, further including powering the one or more light sources through an AC plug extending from a back face of the nightlight wherein the nightlight is configured to be plugged in to a wall outlet.

17. The method of claim 11, wherein the steps of operating the one or more light sources include directly the light sources out peripheral portion of the nightlight so that a substantial length of the peripheral portion is illuminated.

18. The method of claim 11, further including the step of only operating the one or more light sources in the second mode responsive to the detected signal falling within a detected frequency range and meeting a decibel threshold.

19. An emergency lighting device, comprising:
a lighting device housing having a translucent peripheral portion;
a first set of light sources spaced along and directed outward from the translucent peripheral portion and configured to illuminate along at least a substantial length of the peripheral portion;
a second set of light sources pivotally coupled along a bottom of the lighting device housing and configured to illuminate downward from the housing;
means for energizing said first and second set of light sources, said means including a first mode in which at least one of the first and second set of light sources is energized to illuminate with a first non-zero lumen output and a second mode in which at least one of the first and second set of light sources is energized to illuminate with a second non-zero lumen output, wherein said second non-zero lumen output is higher than said first non-zero lumen output; and
an audible signal detector operatively coupled to at least one of said first and second set of light sources to trigger the at least one of said first and second set of light sources to said second mode responsive to a detected audible signal.

20. The emergency lighting device of claim 19, wherein said means for energizing said first and second light sources includes a third mode in which the first and second set of light sources are not energized, said lighting device further including:
a photoelectric cell operatively connected to said means for energizing, wherein said means for energizing is configured to operate in the third mode in response to sufficient illumination of said photoelectric cell, otherwise configured to operate in the first mode in the absence of a trigger by the audible signal detector.

21. The emergency lighting device of claim 19, said second set of light sources mounted in a pivot housing coupled to a bottom of the lighting device housing along a horizontal axis of the pivot housing and in a plane of the lighting device housing to enable light to be selectively directed from said second set of light sources along an arc downward in said plane or outward at an angle from said plane of said lighting device housing.

22. The emergency lighting device of claim 19, further including an AC plug located on a back side of the lighting device housing and electrically coupled to said means for energizing.

23. The emergency lighting device of claim 22, further including a battery enclosed in said housing, electrically coupled to said means for energizing said first and second set of light sources, and configured to provide operating power for said lighting device in the absence of power through said AC plug.

24. The emergency lighting device of claim 19, wherein the trigger to said second mode occurs based on the detected audible signal falling within a detected frequency range and meeting a decibel threshold.
